(19) United States
(12) Patent Application Publication
(10) Pub. No.: US 2025/0037329 A1
(43) Pub. Date: Jan. 30, 2025

(54) CT IMAGE GENERATING METHOD AND IMAGE DATA RECONSTRUCTION DEVICE

(71) Applicant: GE Precision Healthcare LLC, Waukesha, WI (US)

(72) Inventors: Bingjie Zhao, Beijing (CN); Xueli Wang, Beijing (CN); Weiwei Xing, Beijing (CN)

(21) Appl. No.: 18/785,418

(22) Filed: Jul. 26, 2024

(30) Foreign Application Priority Data
Jul. 26, 2023 (CN) 202310929899.4

(51) Int. Cl. G06T 11/00; G06T 5/50

(52) U.S. Cl. CPC G06T 11/008; G06T 5/50; G06T 2207/10081; G06T 2207/20221

(57) ABSTRACT

A Computed Tomography (CT) image generating method and an image data reconstruction device are provided. The method includes acquiring projection measurement data of a subject scanned by a CT device, reconstructing an initial scan image on the basis of the projection measurement data, wherein the initial scan image includes a plurality of slice images, and at least one of the slice images includes a main region image within a scan field of view and a truncated region image out of the scan field of view, determining whether a particular type of substance is present in the plurality of slice images, and performing artifact removal reconstruction on at least one of the slice images in response to determining that the substance is present in a truncated region image of the slice images, the artifact removal reconstruction being used to remove, from the slice images, artifacts caused by the substance.

### CROSS-REFERENCE TO RELATED APPLICATIONS

This application claims priority to Chinese Application No. 202310929899.4, filed on Jul. 26, 2023, the disclosure of which is incorporated herein by reference in its entirety.

### TECHNICAL FIELD

The present disclosure relates to non-invasive diagnostic imaging and, more specifically, to a CT image generating method and an image data reconstruction device.

### BACKGROUND

Computed tomography (CT) systems are widely used in various medical institutions to perform three-dimensional imaging on a region of interest, such as the lungs, of a subject, so as to aid clinicians in accurate medical diagnosis of the subject.

During a CT scan, a detector is used to acquire data of X-rays passing through the body of a patient, and then the acquired X-ray data is processed to acquire projection data. The projection data may be used to reconstruct a slice image. Complete projection data can be used to reconstruct an accurate slice image for diagnosis.

As image data is reconstructed on the basis of projection measurement data, artifacts (particularly metal artifacts) occur frequently. Artifacts are typically caused by an implant (such as a steel pin, a stent, a metal filler, or the like) in the body of a patient under examination. On an image, artifacts may appear as streaks in the slice image, thereby affecting the readability of the reconstructed image.

In order to reduce artifacts in the image representation, special image reconstruction may be performed to remove artifacts, i.e., artifact removal reconstruction. Conventionally, the artifact removal reconstruction is enabled according to a slice image of a diagnostic scan. However, for a conventional diagnostic scan image, only a main region image within a scan field of view of the CT device is reconstructed, whereas a truncated region image out of the scan field of view of the CT device is not reconstructed. When an object that causes an artifact is present in a truncated region, it is difficult to enable artifact removal reconstruction according to the main region image.

### SUMMARY

The objective of the present invention is to overcome the above and/or other problems in the prior art, so that artifact removal reconstruction can be correctly enabled when an object that causes an artifact is present in a truncated region.

According to a first aspect of the present invention, a CT image generating method is provided, comprising: acquiring projection measurement data of an examination subject scanned by a CT device; reconstructing an initial scan image on the basis of the projection measurement data, wherein the initial scan image comprises a plurality of slice images, and at least one of the plurality of slice images comprises a main region image within a scan field of view of the CT device and a truncated region image out of the scan field of view of the CT device; determining whether a particular type of substance is present in the plurality of slice images; and performing artifact removal reconstruction on at least one of the plurality of slice images in response to determining that the substance is present in a truncated region image of the plurality of slice images, the artifact removal reconstruction being used to remove, from the plurality of slice images, artifacts caused by the substance.

In an embodiment, performing the artifact removal reconstruction on at least one of the plurality of slice images may comprise: determining artifact-affected sub-regions in the slice images, wherein each of the artifact-affected sub-regions indicates the presence of at least one of the substances; performing artifact removal on the artifact-affected sub-regions to acquire artifact-reduced sub-images, and combining at least a portion of the at least one slice image with the artifact-reduced sub-images.

In an embodiment, the method may further include acquiring at least one scout image of the examination subject at at least one plain scan angle, and determining an examination region of the examination subject on the basis of the at least one scout image. In an embodiment, the scout image may be acquired by performing planar projection measurement on the subject at one of the at least one plain scan angle, and the projection measurement data may be acquired by performing circumferential projection measurement on the examination region of the examination subject in an axial direction of a diagnostic scan. In an embodiment, the method may further include determining whether the substance is present in the at least one scout image and within the examination region or within a threshold range from the examination region; and performing the artifact removal reconstruction on at least one of the plurality of slice images in response to determining that the substance is present in the at least one scout image and within the examination region or within the threshold range from the examination region.

In an embodiment, combining at least a portion of the at least one slice image with the artifact-reduced sub-images may include combining at least one sub-image free of any artifact sub-regions in the at least one slice image with the artifact-reduced sub-images. In an embodiment, the artifact-affected sub-regions may comprise a sub-region in which the substance is present and a sub-region in the vicinity of the substance. In an embodiment, the substance may comprise a metallic substance. In an embodiment, the sub-region in the vicinity of the substance may be further determined on the basis of one or more of the following: the position of the substance; the type of the substance; the size of the substance; and the shape of the substance. In an embodiment, whether the substance is present in each of the plurality of slice images may be determined by means of deep learning.

According to a second aspect of the present invention, an image data reconstruction device is provided, including a data acquisition unit, configured to acquire projection measurement data of an examination subject scanned by a CT device, a reconstruction unit, configured to reconstruct an original scan image on the basis of the projection measurement data, wherein the original scan image comprises a plurality of slice images, and at least one of the plurality of slice images comprises a main region image within a scan field of view of the CT device and a truncated region image out of the scan field of view of the CT device, and a correction unit, configured to perform artifact removal reconstruction on the original scan image, the correction unit including a detection unit, configured to determine whether a particular type of substance is present in the plurality of slice images; and an artifact removal reconstruction unit, configured to perform artifact removal reconstruction on at least one of the plurality of slice images in response to determining that the substance is present in a truncated region image of the plurality of slice images, the artifact removal reconstruction being used to remove, from the plurality of slice images, artifacts caused by the substance.

In an embodiment, the artifact removal reconstruction unit may be configured to determine artifact-affected sub-regions in the slice images at least on the basis of the position of the substance, wherein each of the artifact-affected sub-regions indicates the presence of at least one of the substances; perform the artifact removal reconstruction on the artifact-affected sub-regions at least on the basis of the position of the substance to acquire artifact-reduced sub-images, and combine at least a portion of the at least one slice image with the artifact-reduced sub-images.

In an embodiment, the data acquisition unit may be further configured to acquire at least one scout image of the examination subject at at least one plain scan angle. In an embodiment, the scout image may be acquired by performing planar projection measurement on the subject at one of the at least one plain scan angle, and the projection measurement data may be acquired by performing circumferential projection measurement on the examination region of the examination subject in an axial direction of a diagnostic scan.

In an embodiment, the detection unit may be further configured to determine whether the substance is present in the at least one scout image and within the examination region or within a threshold range from the examination region, and the artifact removal reconstruction unit is further configured to perform the artifact removal reconstruction on at least one of the plurality of slice images in response to determining that the substance is present in the at least one scout image and within the examination region or within the threshold range from the examination region.

In an embodiment, the artifact removal reconstruction unit may be further configured to combine at least one sub-image free of any artifact sub-regions in the at least one slice image with the artifact-reduced sub-images. In an embodiment, the artifact-affected sub-regions may comprise a sub-region in which the substance is present and a sub-region in the vicinity of the substance. In an embodiment, the substance may comprise a metallic substance. In an embodiment, the sub-region in the vicinity of the substance may be further determined on the basis of one or more of the following the position of the substance; the type of the substance; the size of the substance; and the shape of the substance. In an embodiment, the detection unit may be configured to determine, by means of deep learning, whether the substance is present in each of the plurality of slice images.

According to a third aspect of the present invention, a computed tomography system is provided, including a scanner unit, configured to acquire projection measurement data of an examination subject; a control device, configured to control the scanner unit; and the image data reconstruction device described above.

According to a fourth aspect of the present invention, a non-transient machine-readable medium is provided, including a plurality of instructions, wherein when the plurality of instructions are executed by a processor, the processor is caused to perform the method described above.

### BRIEF DESCRIPTION OF THE DRAWINGS

The present invention can be better understood by means of the description of the exemplary embodiments of the present invention in conjunction with the drawings, in which:

FIG. 1 shows a schematic diagram of an exemplary CT imaging system 100;

FIG. 2 shows a block diagram of an exemplary imaging system 200 similar to the CT imaging system 100 in FIG. 1;

FIG. 3(A) shows a scout image acquired directly above a subject 112;

FIG. 3(B) shows a scout image acquired from a side of the subject 112;

FIG. 4(A) shows a reconstructed uncorrected scan image;

FIG. 4(B) shows an image after artifact removal reconstruction;

FIG. 5 illustrates a flowchart of an exemplary procedure 500 for generating a CT image according to techniques of the present disclosure;

FIG. 6(A) and FIG. 6(B) illustrate schematic diagrams of a scan field of view of the CT imaging system 100;

FIG. 7 illustrates an exemplary slice image of an initial scan image according to techniques of the present disclosure;

FIG. 8 illustrates a comparison between slice images before and after artifact removal reconstruction according to techniques of the present disclosure, wherein the left is a slice image of an initial scan image without the enabling of the artifact removal reconstruction, and the right is a corresponding slice image after the artifact removal reconstruction is enabled;

FIG. 9 illustrates a flowchart of an exemplary procedure 900 for performing artifact removal reconstruction on a slice image according to techniques of the present disclosure;

FIG. 10 illustrates a flowchart of another exemplary procedure 1000 for generating a CT image according to techniques of the present disclosure;

FIG. 11 illustrates a block diagram of an exemplary image data reconstruction device 300 according to techniques of the present disclosure; and

FIG. 12 illustrates an exemplary block diagram of a computing device 1200 according to techniques of the present disclosure.

In the accompanying drawings, similar components and/or features may have the same numerical reference signs. Further, components of the same type may be distinguished by letters following the reference sign, and the letters may be used for distinguishing between similar components and/or features. If only a first numerical reference sign is used in the specification, the description is applicable to any similar component and/or feature having the same first numerical reference sign irrespective of the subscript of the letter.

### DETAILED DESCRIPTION

Specific embodiments of the present invention will be described below. It should be noted that in the specific description of said embodiments, for the sake of brevity and conciseness, the present description cannot describe all of the features of the actual embodiments in detail. It should be understood that in the actual implementation process of any embodiment, just as in the process of any one engineering project or design project, a variety of specific decisions are often made to achieve specific goals of the developer and to meet system-related or business-related constraints, which may also vary from one embodiment to another. Furthermore, it should also be understood that although efforts made in such development processes may be complex and tedious, for a person of ordinary skill in the art related to the disclosure of the present invention, some design, manufacture, or production changes made on the basis of the technical disclosure of the present disclosure are only common technical means, and should not be construed as the content of the present disclosure being insufficient.

References in the specification to “an embodiment,” “embodiments,” “exemplary embodiment,” and so on indicate that the embodiment(s) described may include a specific feature, structure, or characteristic, but the specific feature, structure, or characteristic is not necessarily included in every embodiment. Besides, such phrases do not necessarily refer to the same embodiment. Further, when a specific feature, structure, or characteristic is described in connection with an embodiment, it is believed that affecting such feature, structure, or characteristic in connection with other embodiments (whether or not explicitly described) is within the knowledge of those skilled in the art.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

Unless defined otherwise, technical terms or scientific terms used in the claims and description should have the usual meanings that are understood by those of ordinary skill in the technical field to which the present invention belongs. The terms “include” or “comprise” and similar words indicate that an element or object preceding the terms “include” or “comprise” encompasses elements or objects and equivalent elements thereof listed after the terms “include” or “comprise”, and do not exclude other elements or objects.

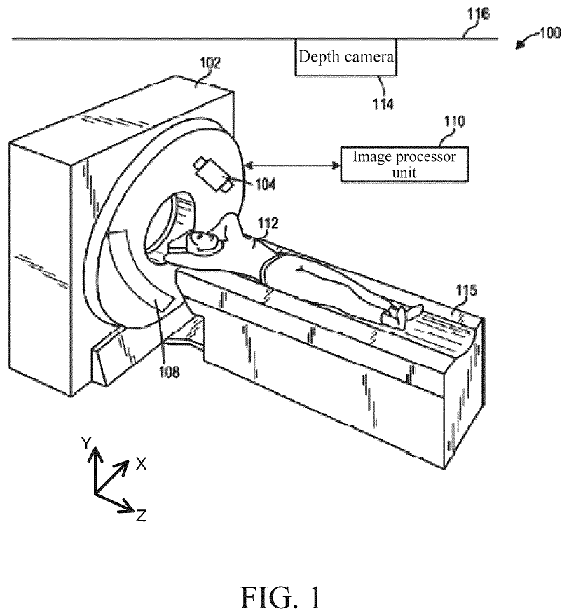

Embodiments of the present disclosure will be described below by way of example with reference to FIG. 1 to FIG. 12, wherein the following description relates to various examples of imaging systems. Specifically, a CT image generating method, an image data reconstruction device, and a computed tomography system are provided. Particular types of substances that cause artifacts as referred to herein may include any metallic objects, non-metallic objects, examination table seams or gaps, components, imaging accessories, and so on that obscure or blur images.

While a CT system is described by way of example, it should be understood that the techniques of the present disclosure may also be useful when applied to images acquired by using other imaging modalities, such as an X-ray imaging system, a magnetic resonance imaging (MRI) system, a positron emission tomography (PET) imaging system, a single photon emission computed tomography (SPECT) imaging system, and combinations thereof (e.g., a multi-modal imaging system such as a PET/CT, PET/MR, or SPECT/CT imaging system). The discussion of the CT imaging system in the present invention is provided only as an example of one suitable imaging system.

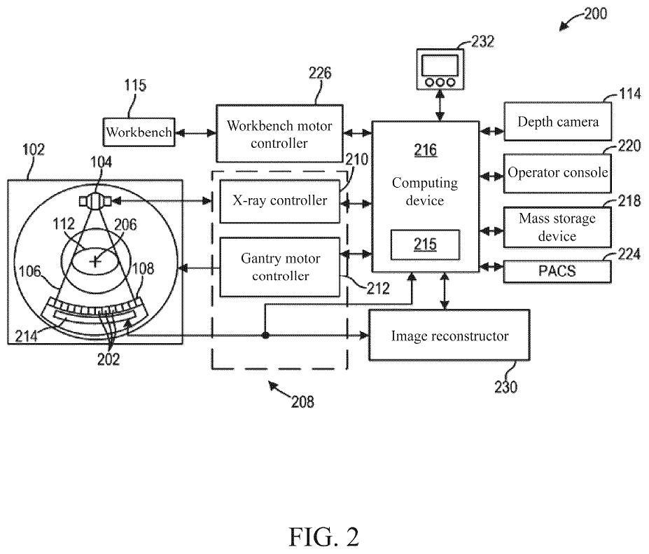

FIG. 1 shows an exemplary CT imaging system 100. Specifically, the CT imaging system (also referred to as CT device) 100 is configured to image a subject 112 (such as a patient, an inanimate subject, one or more manufactured components, industrial components, or foreign subjects, or the like). Throughout the present disclosure, the terms “subject” and “examination subject” may be used interchangeably, and it should be understood that, at least in some embodiments, a patient is a type of subject that may be imaged by the CT imaging system 100, and that a subject may include a patient. In some embodiments, the CT imaging system 100 includes a gantry 102, which may include at least one X-ray radiation source 104. The at least one X-ray radiation source 104 is configured to project an X-ray beam (or X-ray) 106 (see FIG. 2) for imaging the subject 112. Specifically, the X-ray radiation source 104 is configured to project the X-ray 106 toward a detector array 108 positioned on the opposite side of the gantry 102. Although FIG. 1 illustrates only one X-ray radiation source 104, in some embodiments, a plurality of X-ray radiation sources 104 may be used to project a plurality of X-rays 106 toward a plurality of detectors, so as to acquire projection data corresponding to the subject 112 at different energy levels.

In some embodiments, the X-ray radiation source 104 projects the fan-shaped or cone-shaped X-ray beam 106. The fan-shaped or cone-shaped X-ray beam 106 is collimated to be located in an x-y plane of a Cartesian coordinate system, and the plane is generally referred to as an “imaging plane” or a “scanning plane”. The X-ray beam 106 passes through the subject 112. The X-ray beam 106, after being attenuated by the subject 112, is incident on the detector array 108. The intensity of the attenuated radiation beam received at the detector array 108 depends on the attenuation of the X-ray 106 by the subject 112. Each detector element of the detector array 108 produces a separate electrical signal that serves as a measure of the intensity of the beam at the detector position. Intensity measurements from all detectors are separately acquired to generate a transmission distribution.

In third-generation CT imaging systems, the gantry 102 is used to rotate the X-ray radiation source 104 and the detector array 108 within the imaging plane around the subject 112, so that the angle at which the X-ray beam 106 intersects with the subject 112 is constantly changing. A full gantry rotation occurs when the gantry 102 completes a full 360-degree rotation. A set of X-ray attenuation measurements (e.g., projection data) from the detector array 108 at one gantry angle is referred to as a “view”. Thus, the view represents each incremental position of the gantry 102. A “scan” of the subject 112 includes a set of views made at different gantry angles or viewing angles during one rotation of the X-ray radiation source 104 and the detector array 108.

In an axial scan, projection data is processed to construct an image corresponding to a two-dimensional slice captured through the subject 112. A method for reconstructing an image from a set of projection data is referred to as a filtered back projection technique in the art. The method converts an attenuation measurement from a scan into an integer referred to as “CT number” or “Hounsfield unit” (HU), the integer being used to control, for example, the brightness of a corresponding pixel on a cathode ray tube display.

In some examples, the CT imaging system 100 may include a depth camera 114 positioned on or outside the gantry 102. As shown in FIG. 1, the depth camera 114 is mounted on a ceiling panel 116 positioned above the subject 112 and oriented to image the subject when the subject 112 is at least partially outside the gantry 102. The depth camera 114 may include one or more light sensors, including one or more visible light sensors and/or one or more infrared (IR) light sensors. In some embodiments, the one or more IR sensors may include one or more sensors in a near-IR range and a far-IR range to implement thermal imaging. In some embodiments, the depth camera 114 may further include an IR light source. The light sensor may be any 3D depth sensor, such as a time-of-flight (ToF) sensor, a stereo sensor, or a structured light depth sensor, the 3D depth sensor being operable to generate a 3D depth image, while in other embodiments, the light sensor may be a two-dimensional (2D) sensor operable to generate a 2D image. In some such embodiments, a 2D light sensor may be used to infer a depth from knowledge of light reflection to estimate a 3D depth. Regardless of whether the light sensor is a 3D depth sensor or a 2D sensor, the depth camera 114 may be configured to output a signal for encoding an image to a suitable interface. The interface may be configured to receive, from the depth camera 114, the signal for encoding the image. In other examples, the depth camera 114 may further include other components, such as a microphone, so that the depth camera can receive and analyze directional and/or non-directional sound from the observed subject and/or other sources.

In some embodiments, the CT imaging system 100 further includes an image processing unit 110 configured to reconstruct an image of a target volume of a patient by using a suitable reconstruction method (such as an iterative or analytical image reconstruction method). For example, the image processing unit 110 may reconstruct an image of a target volume of a patient by using an analytical image reconstruction method (such as filtered back projection (FBP)). As another example, the image processing unit 110 may reconstruct an image of a target volume of a patient by using an iterative image reconstruction method (such as adaptive statistical iterative reconstruction (ASIR), conjugate gradient (CG), maximum likelihood expectation maximization (MLEM), model-based iterative reconstruction (MBIR), or the like).

As used herein, the phrase “reconstructing an image” is not intended to exclude an embodiment of the present invention in which data representing an image is generated rather than a viewable image. Thus, as used herein, the term “image” broadly refers to both a viewable image and data representing a viewable image. However, many embodiments generate (or are configured to generate) at least one viewable image.

The CT imaging system 100 further includes a workbench 115, and the subject 112 is positioned on the workbench to facilitate imaging. The workbench 115 may be electrically powered, so that a vertical position and/or a lateral position of the workbench can be adjusted. Accordingly, the workbench 115 may include a motor and a motor controller, as will be explained below with respect to FIG. 2. The workbench motor controller moves the workbench 115 by adjusting the motor, so as to properly position the subject in the gantry 102 to acquire projection data corresponding to a target volume of the subject. The workbench motor controller may adjust the height of the workbench 115 (e.g., a vertical position relative to the ground on which the workbench is located) and a lateral position of the workbench 115 (e.g., a horizontal position of the workbench along an axis parallel to a rotation axis of the gantry 102).

FIG. 2 shows an exemplary imaging system 200 similar to the CT imaging system 100 in FIG. 1. In some embodiments, the imaging system 200 includes the detector array 108 (see FIG. 1). The detector array 108 further includes a plurality of detector elements 202, which together acquire the X-ray beam 106 (see FIG. 1) passing through the subject 112 to acquire corresponding projection data. Therefore, in some embodiments, the detector array 108 is fabricated in a multi-slice configuration including a plurality of rows of units or detector elements 202. In such configurations, one or more additional rows of detector elements 202 are arranged in a parallel configuration for acquiring projection data. In some examples, an individual detector in the detector array 108 or the detector elements 202 may include a photon counting detector that registers interactions of individual photons into one or more energy bins. It should be understood that the methods described herein may also be implemented using an energy integration detector.

In some embodiments, the imaging system 200 is configured to traverse different angular positions around the subject 112 to acquire required projection measurement data. Therefore, the gantry 102 and components mounted thereon can be configured to rotate about a center of rotation 206 to acquire, for example, projection measurement data at different energy levels. Alternatively, in embodiments in which a projection angle with respect to the subject 112 changes over time, the mounted components may be configured to move along a substantially curved line rather than a segment of a circumference.

In some embodiments, the imaging system 200 includes a control mechanism 208 to control the movement of the components, such as the rotation of the gantry 102 and the operation of the X-ray radiation source 104. In some embodiments, the control mechanism 208 further includes an X-ray controller 210, configured to provide power and timing signals to the X-ray radiation source 104. Additionally, the control mechanism 208 includes a gantry motor controller 212, configured to control the rotational speed and/or position of the gantry 102 on the basis of imaging requirements.

In some embodiments, the control mechanism 208 further includes a data acquisition system (DAS) 214, configured to sample analog data received from the detector elements 202, and convert the analog data to a digital signal for subsequent processing. The data sampled and digitized by the DAS 214 is transmitted to a computer or computing device 216. In an example, the computing device 216 stores data in a storage apparatus 218. For example, the storage apparatus 218 may include a hard disk drive, a floppy disk drive, a compact disc-read/write (CD-R/W) drive, a digital versatile disc (DVD) drive, a flash drive, and/or a solid-state storage drive.

Additionally, the computing device 216 provides commands and parameters to one or more of the DAS 214, the X-ray controller 210, and the gantry motor controller 212 to control system operations, such as data acquisition and/or processing. In some embodiments, the computing device 216 controls system operations on the basis of operator input. The computing device 216 receives the operator input by means of an operator console 220 that is operably coupled to the computing device 216, the operator input including, for example, commands and/or scan parameters. The operator console 220 may include a keyboard (not shown) or a touch screen to allow the operator to specify commands and/or scan parameters.

Although FIG. 2 shows only one operator console 220, more than one operator console may be coupled to the imaging system 200, for example, for inputting or outputting system parameters, requesting examination, and/or viewing images. Moreover, in some embodiments, the imaging system 200 may be coupled to, for example, a plurality of displays, printers, workstations, and/or similar devices located locally or remotely within an institution or hospital or in a completely different location by means of one or more configurable wired and/or wireless networks (such as the Internet and/or a virtual private network).

In some embodiments, for example, the imaging system 200 includes or is coupled to a picture archiving and communication system (PACS) 224. In one exemplary embodiment, the PACS 224 is further coupled to a remote system (such as a radiology information system or a hospital information system), and/or an internal or external network (not shown) to allow operators in different locations to provide commands and parameters and/or acquire access to image data.

The computing device 216 uses operator-provided and/or system-defined commands and parameters to operate a workbench motor controller 226, which can in turn control a workbench motor, thereby adjusting the position of the workbench 115 shown in FIG. 1. Specifically, the workbench motor controller 226 moves the workbench 115 by means of the workbench motor, so as to properly position the subject 112 in the gantry 102 to acquire projection data corresponding to a target volume of the subject 112. For example, the computing device 216 may send a command to the workbench motor controller 226 to instruct the workbench motor controller 226 to adjust the vertical position and/or the lateral position of the workbench 115 by means of the motor.

As described previously, the DAS 214 samples and digitizes the projection data acquired by the detector elements 202. Subsequently, an image reconstructor 230 uses the sampled and digitized X-ray data to perform high-speed reconstruction. Although the image reconstructor 230 is shown as a separate entity in FIG. 2, in some embodiments, the image reconstructor 230 may form a part of the computing device 216. Alternatively, the image reconstructor 230 may not be present in the imaging system 200, and the computing device 216 may instead perform one or more functions of the image reconstructor 230. In addition, the image reconstructor 230 may be located locally or remotely and may be operably connected to the imaging system 200 by using a wired or wireless network. Specifically, in one exemplary embodiment, computing resources in a “cloud” network cluster are available to the image reconstructor 230.

In some embodiments, the image reconstructor 230 stores the reconstructed image in the storage apparatus 218. Alternatively, the image reconstructor 230 transmits the reconstructed image to the computing device 216 to generate usable subject information (also referred to as examination subject information) for diagnosis and evaluation. In some embodiments, the computing device 216 transmits the reconstructed image and/or subject information to a display 232, the display being communicatively coupled to the computing device 216 and/or the image reconstructor 230. In some embodiments, the display 232 allows an operator to evaluate an imaged anatomical structure. The display 232 may also allow the operator to select a volume of interest (VOI) and/or request subject information, for example, by means of a graphical user interface (GUI), for subsequent scanning or processing.

As described further herein, the computing device 216 may include computer-readable instructions, and the computer-readable instructions are executable to send, according to an examination imaging scheme, commands and/or control parameters to one or more of the DAS 214, the X-ray controller 210, the gantry motor controller 212, and the workbench motor controller 226. The examination imaging scheme includes a clinical task/intent, also referred to herein as a clinical intent identifier (CID) of the examination. For example, the CID may inform a goal (e.g., a general scan or lesion detection, an anatomical structure of interest, a quality parameter, or another goal) of the procedure on the basis of a clinical indication, and may further define the position and orientation (e.g., posture) of the subject required during a scan (e.g., supine and feet first). The operator of the system 200 may then position the subject on the workbench according to the position and orientation of the subject specified by the imaging scheme. Further, the computing device 216 may set and/or adjust various scan parameters (e.g., a dose, a gantry rotation angle, kV, mA, an attenuation filter) according to the imaging scheme. For example, the imaging scheme may be selected by the operator from a plurality of imaging schemes stored in a memory on the computing device 216 and/or a remote computing device, or the imaging scheme may be automatically selected by the computing device 216 according to received subject information.

During the examination/scanning phase, it may be desirable to expose the subject to a radiation dose as low as possible while still maintaining the required image quality. In addition, reproducible and consistent imaging quality between examinations and between subjects, as well as between different imaging system operators, may be required. Thus, an imaging system operator may manually adjust the position of the workbench and/or the position of the subject, so as to, for example, center a desired patient anatomical structure at the center of a gantry bore. However, such a manual adjustment may be error-prone. Thus, the CID associated with the selected imaging scheme may be mapped to various positioning parameters of the subject. The positioning parameters of the subject include the posture and orientation of the subject, the height of the workbench, an anatomical reference for scanning, and a starting and/or ending scan position.

Thus, the depth camera 114 may be operably and/or communicatively coupled to the computing device 216 to provide image data to determine the anatomy of the subject, including the posture and orientation. Additionally, various methods and procedures described further herein for determining the patient anatomy on the basis of image data generated by the depth camera 114 may be stored as executable instructions in a non-transitory memory of the computing device 216.

Additionally, in some examples, the computing device 216 may include a camera image data processor 215 that includes instructions for processing information received from the depth camera 114. The information (which may include depth information and/or visible light information) received from the depth camera 114 may be processed to determine various parameters of the subject, such as the identity of the subject, the physique (e.g., the height, weight, and patient thickness) of the subject, and the current position of the subject relative to the workbench and the depth camera 114. For example, prior to imaging, the body contour or anatomy of the subject 112 may be estimated by using images reconstructed from point cloud data, the point cloud data being generated by the camera image data processor 215 according to images received from the depth camera 114. The computing device 216 may use these parameters of the subject to perform, for example, patient-scanner contact prediction, scan range superposition, and scan key point calibration, as will be described in further detail herein. Further, data from the depth camera 114 may be displayed by means of the display 232.

In some embodiments, information from the depth camera 114 may be used by the camera image data processor 215 to track one or more subjects in the field of view of the depth camera 114. In some examples, skeleton tracking may be performed by using image information (e.g., depth information), in which a plurality of joints of the subject are identified and analyzed to determine the motion, posture, position, and so on of the subject. The positions of joints during the skeleton tracking can be used to determine the above-described parameters of the subject. In other examples, the image information may be directly used to determine the above-described parameters of the subject without skeleton tracking.

On the basis of these positioning parameters of the subject, the computing device 216 may output one or more alerts to the operator regarding patient posture/orientation and examination (e.g., scan) result prediction, thereby reducing the possibility that the subject is exposed to a higher than desired radiation dose and improving the quality and reproducibility of the image generated by the scan. As an example, the estimated body structure may be used to determine whether the subject is in an imaging position specified by the radiologist, thereby reducing the incidence of repeating the scan due to improper positioning. Furthermore, the amount of time an imaging system operator spends positioning the subject can be reduced, allowing more scans to be performed per day and/or allowing additional interaction with the subject.

A plurality of exemplary patient orientations may be determined on the basis of data received from a depth camera (such as the depth camera 114 described in FIG. 1 and FIG. 2). For example, a controller (e.g., the computing device 216 in FIG. 2) may perform patient structure extraction and posture estimation on the basis of images received from the depth camera 114, thereby enabling different patient orientations to be distinguished from each other.

The CT imaging system 100 may perform imaging examination on the basis of a scanning protocol. The scanning protocol is a description of the imaging examination. The scanning protocol may include a description of an involved body part, for example, a medical or colloquial term for the body part. The scanning protocol may provide various parameters and related information for performing scans and post-processing, such as a power value, the duration of radiation, speed of movement, radiation energy, and a time delay between image captures, etc. It is conceivable that any configurable technical parameter that should be used for imaging examination by the imaging system 110 may be defined in the scanning protocol.

The CT imaging system 100 may have an automatic patient positioning function. That is, a patient may be automatically positioned in a scanning start position in an opening of the gantry 102 on the basis of an examination instruction or the scanning protocol, and moved in the Z-axis direction to a scanning end position during scanning and imaging. A conventional automatic patient positioning function may automatically determine the scan range in the horizontal direction on the basis of the anatomical structure to be imaged (e.g., from an examination instruction or the scanning protocol) and the patient structure from the depth camera 114, but the automatic centering thereof can only be substantially for the head or the body and the average body contour center of all scout scan ranges, so that centering accuracy for particular anatomical structures and special patients is not good enough.

During a scan of the CT imaging system 100, the subject 112 is properly positioned in the gantry 102, and the computing device 216 controls the rotation of the gantry 102 by means of the gantry motor controller 212 so that the X-ray radiation source 104 and the corresponding detector array 108 move along a circle or an arc around the subject 112 while acquiring projection data. The computing device 216 may simultaneously control the movement of the workbench 115 in an axial direction (also referred to as an axial direction of a diagnostic scan, i.e., the Z-axis direction in FIG. 1) by means of the workbench motor controller 226 to acquire projection data of a three-dimensional target volume (also referred to as an examination region) of the subject 112. This procedure is referred to as a “diagnostic scan”. As the subject 112 moves with the workbench 115, a plurality of sets of projection data may be acquired at certain time intervals to reconstruct a plurality of slice images. Each slice image corresponds to one set of projection data, and represents an image of a certain cross section in the axial direction within the examination region. This set of slice images can be used for diagnosis.

Since the radiation dose to the subject 112 is large in a diagnostic scan, it is sometimes desirable to accurately determine the examination region before the diagnostic scan starts, so as to reduce an unnecessary radiation dose. To this end, a scout scan (also referred to as a plain scan or a positioning scan) may optionally be performed prior to the diagnostic scan. The scout scan captures the subject 112 at at least one plain scan angle while the subject 112 remains stationary. The plain scan angle indicates the positions of the X-ray radiation source 104 and the corresponding detector array 108 in the circumferential direction of the subject 112.

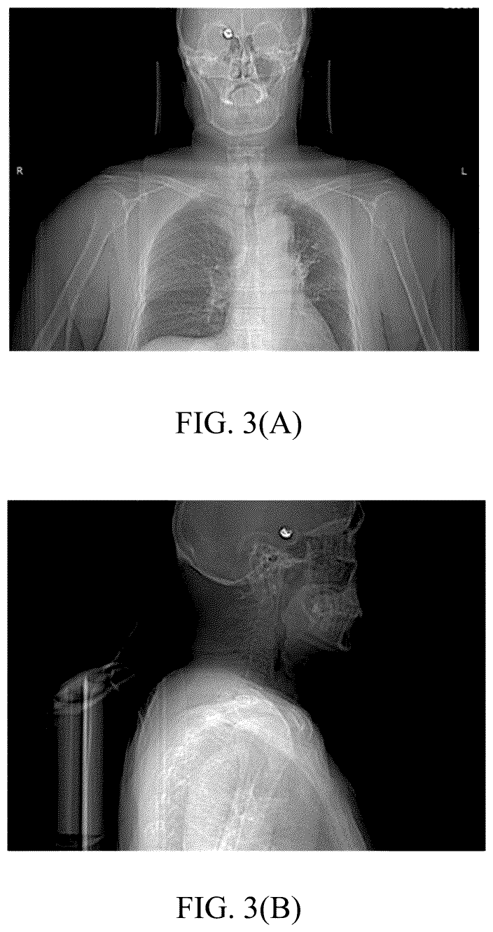

Unlike a diagnostic scan which needs to acquire projection data of a plurality of cross sections in an axial direction of a three-dimensional examination region of the subject 112, one scout scan only requires acquisition of static projection data at one plain scan angle, resulting in a very small radiation dose. FIG. 3(A) shows a scout image acquired directly above the subject 112, and FIG. 3(B) shows a scout image acquired from a side of the subject 112. By using the scout image, the operator can further determine the examination region to be captured by the diagnostic scan. Specifically, a scout image of a region of interest (e.g., the lungs) may be acquired first, and an examination region to be subjected to a diagnostic scan is then determined therefrom. For example, the operator may mark, according to the scout image, the boundary of the examination region for the diagnostic scan in the axial direction (the Z-axis in FIG. 1) of the diagnostic scan.

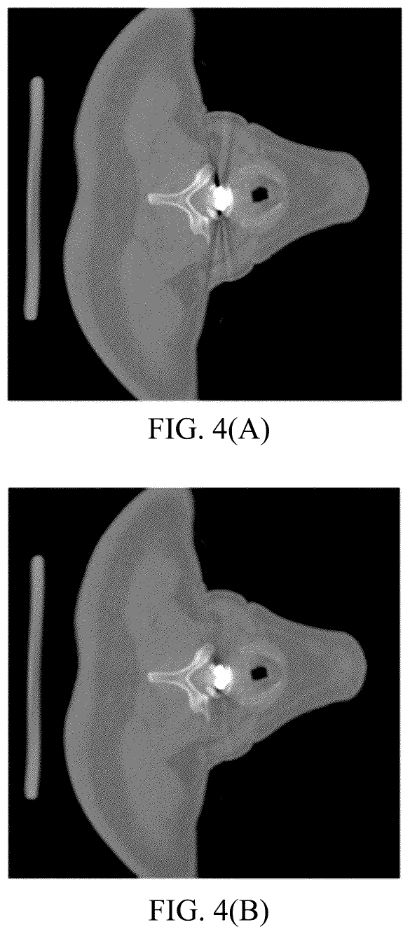

There may be particular types of substances inside or outside the subject 112 that cause artifacts in images. Such substances may include any metallic objects, non-metallic objects, examination table seams or gaps, components, imaging accessories, and so on that obscure or blur images. For example, the presence of a metal implant affects a reconstructed scan image. Typically, the presence of a metallic object results in a large number of black and bright radial streak artifacts around the metal in a reconstructed image, and when the metallic object is large, the determination of an examination result by a physician is seriously affected. FIG. 4(A) shows a reconstructed uncorrected scan image.

Artifacts are mainly caused by the following reasons: When a substance of a particular type (e.g., higher density) is implanted in the inside of the subject 112, an attenuation coefficient thereof is much greater than that of the rest of the inside of the subject 112, so that radiation passing through the substance is significantly weakened, resulting in beam hardening that causes the first derivative of projection data to exhibit weak smoothness in a certain section, resulting in a jump in the projection data. Such weak smoothness is further amplified after filtering processing, so that alternately bright and dark streak artifacts are finally formed in the reconstructed image. In addition, due to X-ray hardening problems, non-linear partial volume effects occur and scattering is exacerbated, which all cause distortions of the reconstructed image, especially a large amount of interference around the substance. There are various methods for removing an artifact. For example, an iterative reconstruction algorithm may be used to remove a metal artifact, or an artifact may be removed in a projection domain, or an artifact may be removed in an image domain. FIG. 4(B) shows an image after artifact removal reconstruction. Compared with the uncorrected scan image shown in FIG. 4(A), the bright and dark streaks caused by the artifact are removed.

In general, the artifact removal function may only be enabled when deemed necessary after visual examination performed by a physician, technician, or the like when viewing a scan image of a diagnostic scan. In other words, the artifact removal function is enabled upon generation of an initial scan image including a plurality of slice images. Here, the initial scan image is a set of slice images acquired by means of the diagnostic scan described above. However, for a conventional diagnostic scan image, only a main region image within a scan field of view of the CT device is reconstructed, whereas a truncated region image out of the scan field of view of the CT device is not reconstructed. When an object that causes an artifact is present in a truncated region, it is difficult to enable artifact removal reconstruction according to the main region image.

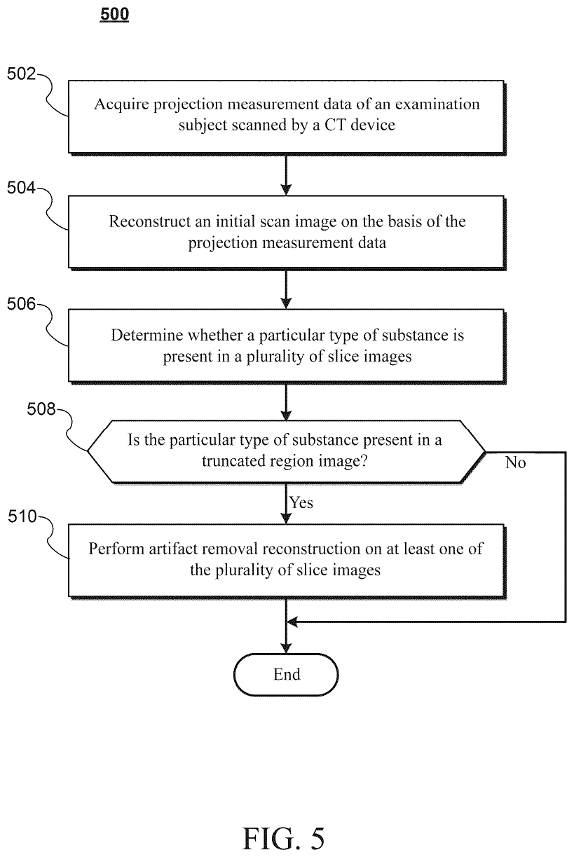

In view of this, the present disclosure provides a CT image generating method, so that artifact removal reconstruction can be correctly enabled when an object that causes an artifact is present in a truncated region. FIG. 5 illustrates a flowchart of an exemplary procedure 500 for generating a CT image according to techniques of the present disclosure.

The procedure 500 starts at block 502. In block 502, projection measurement data of a subject 112 is acquired. The projection measurement data is from a diagnostic scan performed by the imaging system (CT device) 200. Specifically, the computing device 216 may send a command and/or control parameter to one or a plurality among the DAS 214, the X-ray controller 210, the gantry motor controller 212, or the workbench motor controller 226 according to an examination imaging scheme, so as to perform a diagnostic scan on the subject 112 and acquire projection measurement data of an examination region of the subject 112.

In block 504, an initial scan image is reconstructed on the basis of the projection measurement data acquired in block 502. As described above, when performing the diagnostic scan, the computing device 216 performs control to cause the X-ray radiation source 104 and the corresponding detector array 108 to move along a circle or an arc around the subject 112, and simultaneously controls movement of the workbench 115 in an axial direction of the diagnostic scan by means of the workbench motor controller 226, so as to acquire the projection measurement data of the examination region of the subject 112. As the subject 112 moves with the workbench 115, a plurality of sets of projection data may be acquired at certain time intervals to reconstruct a plurality of slice images. Each slice image corresponds to one set of projection data representing an image of a certain cross section in the axial direction within the examination region. Thus, the reconstructed initial scan image includes a plurality of slice images.

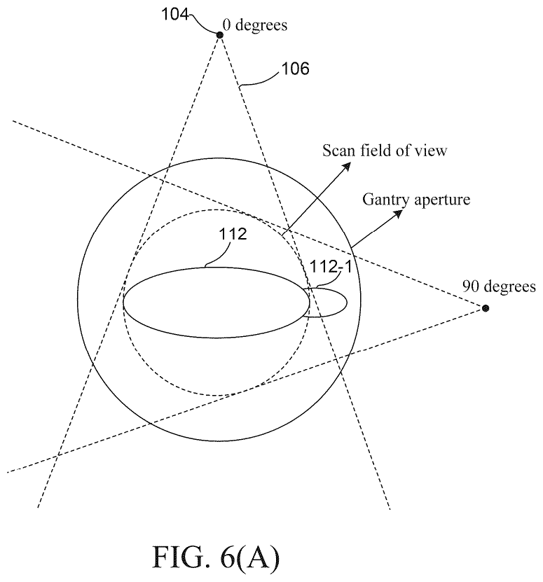

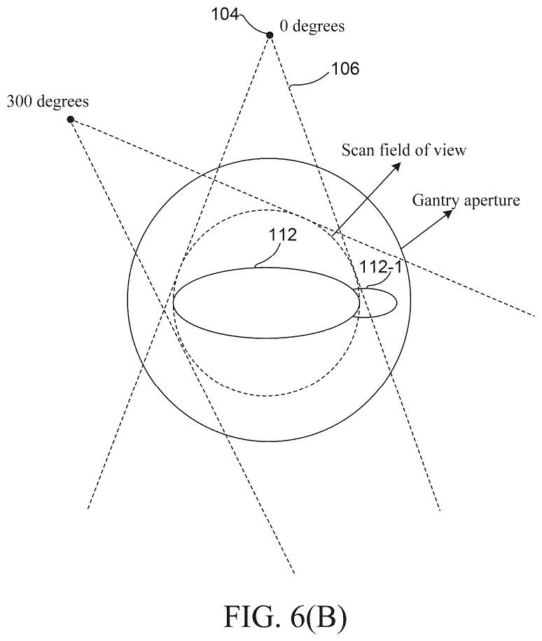

In the present embodiment, at least one of the reconstructed slice images includes a main region image in the field of view of the CT imaging system 100 and a truncated region image out of the scan field of view of the CT device. The scan field of view of the CT imaging system 100 is described below with reference to FIG. 6(A) and FIG. 6(B). FIG. 6(A) and FIG. 6(B) illustrate schematic diagrams of the scan field of view of the CT imaging system 100. During a diagnostic scan, the X-ray radiation source 104 is controlled to move along a circumference or arc around the subject 112. The subject 112 lies on the workbench 115, so as to be located in a gantry aperture of the gantry 102. FIG. 6(A) shows the situations in which the X-ray radiation source 104 is respectively located at 0-degree and 90-degree positions in the circumferential direction. The X-ray radiation source 104 has a fixed (e.g., fan-shaped) radiation field, as shown by the X-ray beam 106 in the figure. Thus, as the X-ray radiation source 104 moves circumferentially around the subject 112, a circular region formed by intersection of radiation fields in various positions is the scan field of view of the CT imaging system 100, as indicated by a dashed circle indicated by an arrow in the drawing.

Conventionally, when reconstructing projection measurement data of a diagnostic scan, only a main region image in the scan field of view is reconstructed because projection data of this part of the image is continuous. In other words, the X-ray radiation source 104 can produce projection measurement data in the scan field of view at any angle relative to the subject 112. However, depending on elements such as the posture and size of the subject 112, a portion of the subject 112 may be in a truncated region out of the scan field of view, as shown by a portion 112-1 in FIG. 6(A). The truncated region is defined by the radiation field of the X-ray radiation source 104, the scan field of view, and the gantry aperture of the gantry 102.

Projection measurement data of the truncated region is discontinuous. For example, for the portion 112-1, when the X-ray radiation source 104 is located in the 0-degree position shown in FIG. 6(A), complete projection measurement data cannot be acquired. When the X-ray radiation source 104 moves to the 90-degree position or a 300-degree position shown in FIG. 6(B), projection measurement data of the portion 112-1 can be acquired. Therefore, although the projection measurement data of the diagnostic scan includes the projection measurement data of the main region image in the scan field of view and the projection measurement data of the truncated region image out of the scan field of view, only the projection measurement data of the main region image is reconstructed conventionally. The acquired initial scan image includes only slice images corresponding to the main region image.

However, in the present embodiment, at the time of reconstructing the initial scan image, the projection measurement data of the truncated region out of the scan field of view is also reconstructed to acquire slice images including both the main region image and the truncated region image.

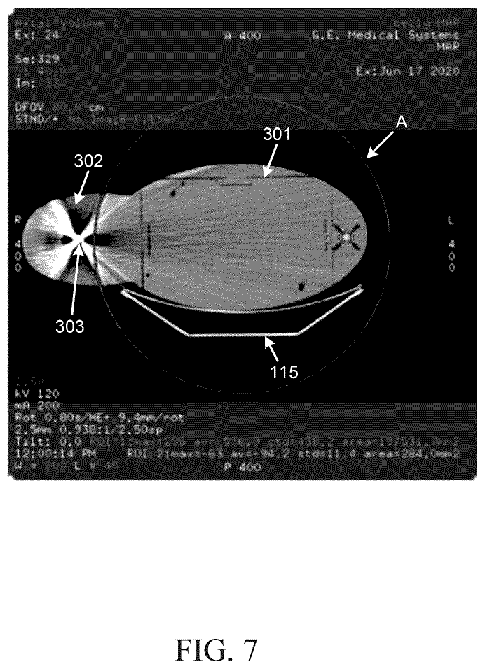

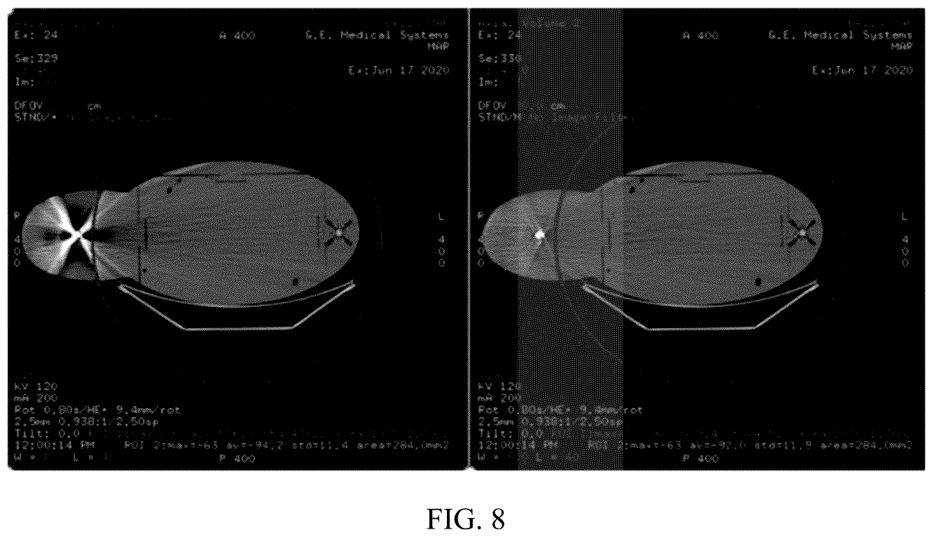

FIG. 7 illustrates an exemplary slice image in an initial scan image according to techniques of the present disclosure. In the example shown in FIG. 7, a circle A represents a scan field of view. An image 301 in the circle A is a main region (slice) image. For a truncated region out of the scan field of view, a truncated region image 302 is also reconstructed. The truncated region image 302 may be reconstructed from projection measurement data of a diagnostic scan.

The truncated region image 302 may be reconstructed by using any known algorithm or any algorithm to be developed in the future, which is not limited herein. As an example, truncated projection data may be predicted by means of a mathematical model or a neural network. For example, a truncated portion may be predicted by using a water model. Optionally, projection measurement data may be preprocessed to perform reconstruction to acquire an initial image of the truncated portion. The initial image is then calibrated on the basis of a trained learning network to acquire a predicted image of the truncated portion. The preprocessing includes padding the truncated portion of the projection data. For example, the truncated portion is padded with projection data information at a boundary of an untruncated portion. As a result, the truncated region image 302 can be reconstructed according to discontinuous partial data in the projection measurement data.

Returning to FIG. 5, in block 506, whether a particular type of substance is present in the plurality of slice images reconstructed in block 504 is determined. As mentioned above, the particular type of substance is a substance that causes image artifacts, and may be, for example, a metal. Since the reconstructed initial scan image of the present disclosure includes the main region image 301 in the scan field of view and the truncated region image 302 out of the scan field of view, whether a particular type of substance is present in the main region image 301 and whether a particular type of substance is present the truncated region image 302 are both detected in block 506.

Detection of the substance may be performed by using a variety of methods. For example, a substance with higher density has more significant brightness in the image than surrounding voxels. In such a situation, detection can be performed by using a simple threshold method. However, when the difference in brightness between the substance and surrounding voxels is small, for example, when a high-density structure such as a bone exists around a metal, it is difficult to perform detection by using the threshold method. In this case, the accuracy of detection may be improved by means of deep learning. In the example in FIG. 7, a substance 303 can be detected.

In block 508, whether a substance 303 is detected in the truncated region image is determined.

In block 510, artifact removal reconstruction is performed on at least one of the plurality of slice images in response to determining, in block 508, that the particular type of substance 303 is present in the truncated region image of the plurality of slice images reconstructed in block 504. The artifact removal reconstruction is performed to reduce or remove, from the plurality of slice images, artifacts caused by the substance 303.

If it is determined in block 508 that the particular type of substance 303 is not present in the truncated region image of the plurality of slice images reconstructed in block 504, the initial scan image reconstructed in block 504 is used as a final diagnostic scan image.

In the present embodiment, the artifact removal reconstruction is automatically enabled upon detecting that the particular type of substance 303 is present in the truncated region of the slice image. A person, such as a physician, a technician, or the like, viewing the slice image can directly acquire a scan image after the artifact removal reconstruction, or both the scan image after the artifact removal reconstruction and the initial scan image. In addition, the initial scan image reconstructed in the present embodiment includes both the main region image 301 in the scan field of view and the truncated region image 302 out of the scan field of view, so that when the substance 303 is not present in the scan field of view but is present in the truncated region, the artifact removal reconstruction can be correctly enabled. In contrast, a conventionally reconstructed scan image includes only the main region image 301. The artifact removal reconstruction is therefore not enabled when the substance 303 is not present in the scan field of view but is present in the truncated region. In this case, the substance 303 in the truncated region may still generate artifacts in the adjacent main region image 301. Using the techniques of the present disclosure can mitigate the situation in which the main region image 301 is affected by artifacts of the substance 303 in the truncated region. FIG. 8 illustrates a comparison between slice images before and after artifact removal reconstruction according to techniques of the present disclosure, wherein the left is a slice image of an initial scan image without the enabling of the artifact removal reconstruction, and the right is a corresponding slice image after the artifact removal reconstruction is enabled. As can be seen, the artifacts generated in the main region image 301 by the substance 303 in the truncated region are faded out.

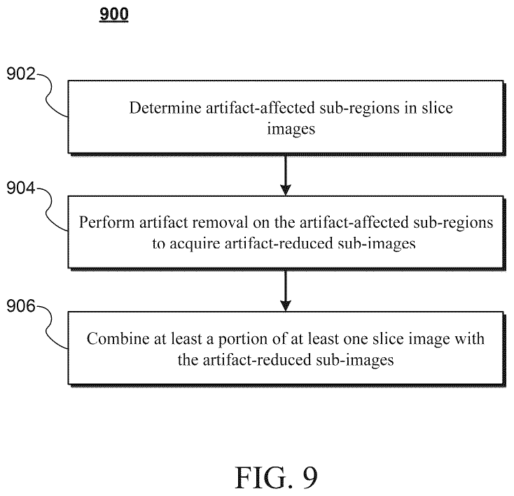

FIG. 9 illustrates a flowchart of an exemplary procedure 900 for performing artifact removal reconstruction on a slice image according to techniques of the present disclosure. In block 902, artifact-affected sub-regions in slice images are determined. In particular, an examination region and a truncated region are divided into a plurality of sub-regions. However, it is determined in which sub-regions of the examination region and the truncated region the artifacts occur. The position of the artifact and the extent of the artifact in the examination region and the truncation region are determined, thereby defining the artifact-affected sub-region. Such artifact determination may be performed by means of features and characteristics of the determined image data and projection measurement data (e.g., attenuation or density values in specific regions). In some embodiments, the artifact-affected sub-region to subsequently undergo the artifact removal reconstruction may be defined on the basis of the detected substance 303 and the position thereof. The step may be performed, for example, according to the determined density (i.e., material density) at corresponding positions in the examination region and the truncated region. An extremely dense region indicates the presence of the substance 303.

In some embodiments, the artifact-affected sub-regions may include a sub-region in which the substance 303 is located and a sub-region in the vicinity of the substance 303. The sub-region in the vicinity of the substance 303 may be determined according to a desired effect of the artifact removal reconstruction. For example, the sub-region in the vicinity of the substance 303 may be a sub-region adjacent to the sub-region in which the substance 303 is present. In some embodiments, the sub-region in the vicinity of the substance 303 may be a sub-region within a certain range around the sub-region in which the substance 303 is present.

In some embodiments, the sub-region in the vicinity of the substance 303 may be determined on the basis of one or more of the following: the position of the substance 303, the type of the substance 303, the size of the substance 303, and the shape of the substance 303. This information can be acquired by performing detection on the initial scan image and a scout image described below.

In block 904, artifact removal is performed on the artifact-affected sub-regions to acquire artifact-reduced sub-images. Only artifact-reduced sub-image data of the artifact-affected sub-regions is generated. When the artifact is a metal artifact, the artifact is corrected with the help of, for example, a so-called iterative metal artifact reduction (iMAR) reconstruction method. In general, artifact-reducing image reconstruction includes image reconstruction methods that may be utilized to reduce image artifacts.

In block 906, at least a portion of at least one slice image is combined with the artifact-reduced sub-images to generate artifact-reduced image data of an initial scan image. The image data for combination may be the following image data: in block 504 in which the initial scan image is generated, the image data has already been reconstructed on the basis of the acquired projection measurement data. The image for combination with the artifact-reduced sub-images may be at least one sub-image free of any artifact sub-regions in the slice image. In some embodiments, determination of a region or sub-region having an artifact is performed not after the reconstruction of the initial scan image, but during the reconstruction of the initial scan image.

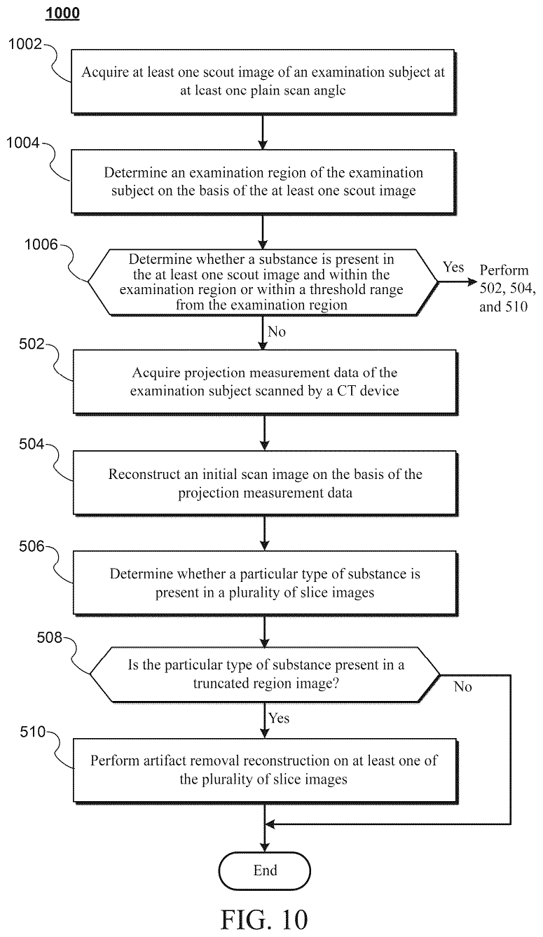

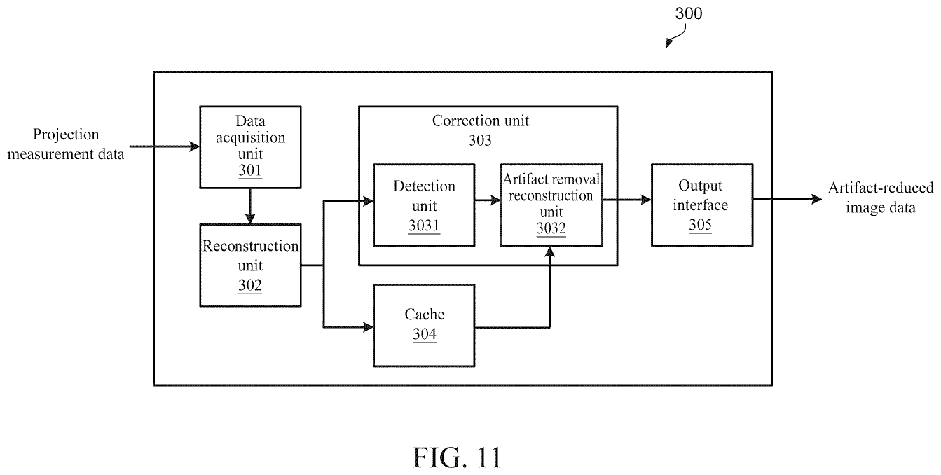

FIG. 10 illustrates a flowchart of another exemplary procedure 1000 for generating a CT image according to techniques of the present disclosure. In the present embodiment, a scout scan is performed before a diagnostic scan, and detection of a particular type of substance is performed on the scout image acquired by means of the scout scan.

Specifically, in block 1002, at least one scout image of an examination subject (the subject 112) is acquired at at least one plain scan angle. The “plain scan angle” here is the angle of the X-ray radiation source 104 with respect to the subject 112 on the XY plane (refer to FIG. 1), for example, 0 degrees, 90 degrees, 300 degrees, or the like as shown in FIG. 6(A) and FIG. 6(B). The scout scan, as described above, is a static scan performed by the X-ray radiation source 104 at a certain plain scan angle, and acquired scout images, for example, are as shown in FIG. 3(A) and FIG. 3(B). The scout scan has a lower radiation dose, and can be used to determine an examination region subjected to a diagnostic scan.

In block 1004, an examination region of the subject 112 is determined on the basis of the at least one scout image. In some embodiments, a three-dimensional boundary of the examination region may be determined on the basis of scout images at two different plain scan (e.g., orthogonal) angles.

In block 1006, whether a substance 303 is present in the at least one scout image and within the examination region or within a threshold range from the examination region is determined. It should be noted here that the scout image is different from the reconstructed slice image. A scout image is an image acquired by performing a planar scan on a three-dimensional portion of the subject 112, and information of three-dimensional voxels is superimposed on a planar image. A slice image is acquired by axially performing a computed tomography scan on a three-dimensional portion of the subject 112, and each slice image includes information of a cross section of the three-dimensional portion. Thus, a scout image includes more overlapping voxel information than a single slice image. It is more difficult to detect the substance 303 in the scout image than in the slice image. Therefore, in the present embodiment, the substance 303 is detected from the scout image by using deep learning.

If the presence of the substance 303 in the scout image is not detected in block 1006, a procedure 500, i.e., blocks 502, 504, 506, 508, and 510, described with reference to FIG. 5 is further performed. In other words, a diagnostic scan is performed and detection of the substance 303 is performed on a slice image acquired by means of the diagnostic scan, especially in a truncated region. This is because the scout image may not include image information of the truncated region, which depends on the plain scan angle. Therefore, it is necessary to further perform detection of the substance 303 on the slice image including the truncated region in block 506, to avoid the artifact removal reconstruction not being correctly enabled due to the presence of the substance 303 in the truncated region.

If the presence of the substance 303 in the scout image is detected in block 1006, it can be determined that artifact removal reconstruction is to be performed on the slice image of the diagnostic scan. In this case, block 506 may be skipped, and blocks 502, 504, and 510 are performed. In some embodiments, the artifact-affected sub-regions in the slice images may also be determined in block 504, as described in block 902. In some embodiments, block 506 may still be performed to determine whether other substances 303 are also present in the truncated region. Position information of the other substances 303 detected in the truncated region may be used to improve the effect of artifact removal reconstruction.

FIG. 11 illustrates a block diagram of an exemplary image data reconstruction device 300 according to techniques of the present disclosure. The image data reconstruction device 300 may be part of the computing device 216 shown in FIG. 2. Alternatively, the image data reconstruction device 300 may serve as a substitute for the image reconstructor 230. In some embodiments, the image data reconstruction device 300 may not be present in the imaging system 200, and the computing device 216 may instead perform one or more functions of the image data reconstruction device 300. In addition, the image data reconstruction device 300 may be located locally or remotely and may be operably connected to the imaging system 200 by using a wired or wireless network. Specifically, in one exemplary embodiment, computing resources in a “cloud” network cluster are available to the image data reconstruction device 300.

The image data reconstruction device 300 has a data acquisition unit 301 that receives projection measurement data of the subject 112 from the DAS 214 (refer to FIG. 2) of the imaging system 200. The projection measurement data is forwarded to a reconstruction unit 302 configured to reconstruct an original scan image on the basis of the projection measurement data. The reconstructed original scan image is then cached in a cache 304.

The image data reconstruction device 300 further includes a correction unit 303. The correction unit 303 includes a detection unit 3031 and an artifact removal reconstruction unit 3032. The detection unit 3031 performs detection on the original scan image received from the reconstruction unit, to determine whether a particular type of substance 303 is present in a plurality of slice images thereof. The artifact removal reconstruction unit 3032 performs artifact removal reconstruction on the slice image of the original scan image when the detection unit 3031 determines that the substance 303 is present in a truncated region image in the slice image of the original scan image. To this end, the artifact removal reconstruction unit 3032 may be configured to perform the procedure 900 shown in FIG. 9. When at least a portion of at least one slice image is combined with artifact-reduced sub-images, at least a portion, e.g., a sub-image free of any artifact sub-regions, of the slice images for combination with the artifact-reduced sub-images may be acquired from the cache 304. Generated (combined) artifact-reduced image data of the subject 112 is then output to the storage apparatus 218 or the display 232 by means of an output interface 305.

In some embodiments, the data acquisition unit 301 may also perform block 1002 to acquire at least one scout image of the subject 112 at at least one plain scan angle.

In some embodiments, the detection unit 301 may be further configured to determine whether the substance 303 is present in the at least one scout image and within an examination region or within a threshold range from the examination region. The artifact removal reconstruction unit 3032 may be further configured to perform the artifact removal reconstruction on at least one slice image when the detection unit 301 determines that the substance 303 is present in the at least one scout image and within the examination region or within the threshold range from the examination region.

The present disclosure also provides a computed tomography system, including a scanner unit, a control device, and the image data reconstruction device 300 described with reference to FIG. 11. The scanner unit includes the X-ray radiation source 104, the detector elements 202, and the DAS 214 described with reference to FIG. 1 and FIG. 2, and is configured to acquire projection measurement data of the subject 112. The scanner unit is controlled by the control device, such as the computing device 216 described with reference to FIG. 2, to acquire a control signal to perform a scan according to a predetermined measurement protocol and acquire projection measurement data. The projection measurement data acquired by the scanner unit is further processed by the image data reconstruction device 300 to implement the procedures (procedures 500, 900, and 1000) described herein.

All or part of the image data reconstruction device 300 may be implemented as a computer program product accessible from a computer (processor)—usable or computer-readable medium. A computer-usable or computer-readable medium may be any device that can, for example, tangibly contain, store, transmit, or transfer a program for use by or in combination with any processor. The medium may be, for example, an electrical, magnetic, optical, electromagnetic, or semiconductor device. Other suitable media are also applicable.

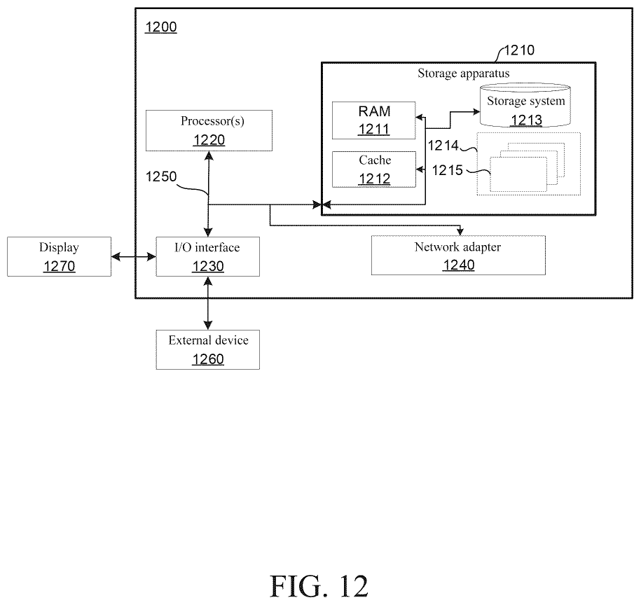

FIG. 12 illustrates an exemplary block diagram of a computing device 1200 according to techniques of the present disclosure. The computing device 1200 may be implemented as an example of the computing device 216 shown in FIG. 2. The computing device 1200 includes: one or a plurality of processors 1220; and a storage apparatus 1210 configured to store one or a plurality of programs, wherein when the one or plurality of programs are executed by the one or plurality of processors 1220, the one or plurality of processors 1220 are caused to implement the procedures described in the present disclosure. The processor is, for example, a digital signal processor (DSP), a microcontroller, an application-specific integrated circuit (ASIC), or a microprocessor.

The computing device 1200 shown in FIG. 12 is merely an example, and should not impose any limitation to the function and usage scope of the embodiments of the present invention.

As shown in FIG. 12, the computing device 1200 is represented in the form of a general-purpose computing device. Assemblies of the computing device 1200 may include, but are not limited to: one or a plurality of processors 1220, a storage apparatus 1210, and a bus 1250 connecting different system assemblies (including the storage apparatus 1210 and the processor 1220).

The bus 1250 indicates one or a plurality of types among several types of bus structures, including a memory bus or a memory controller, a peripheral bus, a graphics acceleration port, a processor, or a local bus using any bus structure of the plurality of bus structures. For example, these architectures include, but are not limited to, an industry standard architecture (ISA) bus, a microchannel architecture (MAC) bus, an enhanced ISA bus, a video electronics standards association (VESA) local bus, and a peripheral component interconnection (PCI) bus.

The computing device 1200 typically includes a plurality of computer system readable media. These media may be any available medium that can be accessed by the computing device 1200, including volatile and non-volatile media as well as movable and non-movable media.

The storage apparatus 1210 may include a computer system readable medium in the form of a volatile memory, for example, a random access memory (RAM) 1211 and/or a cache memory 1212. The computing device 1200 may further include other movable/non-movable, and volatile/non-volatile computer system storage media. For example only, a storage system 1213 may be configured to read and write a non-removable non-volatile magnetic medium (which is not shown in FIG. 12, and is generally referred to as a “hard drive”). Although not shown in FIG. 12, a magnetic disk drive used for reading/writing a movable non-volatile magnetic disk (for example, a “floppy disk”) and an optical disk drive used for reading/writing a movable non-volatile optical disk (for example, a CD-ROM, a DVD-ROM, or other optical media) may be provided. In these cases, each drive may be connected to the bus 1250 by means of one or a plurality of data medium interfaces. The storage apparatus 1210 may include at least one program product, the program product has a group (for example, at least one) of program modules, and these program modules are configured to perform the functions of the various embodiments in the present invention.

A program/utility tool 1214 having a group of program modules (at least one program module) 1215 may be stored in, for example, the storage apparatus 1210. Such a program module 1215 includes, but is not limited to, an operating system, one or a plurality of applications, other program modules, and program data. It is possible for each one or a certain combination of these examples to include implementations of a network environment. The program module 1215 typically performs the function and/or method in any embodiment described in the present invention.

The computing device 1200 may also communicate with one or a plurality of peripheral devices 1260 (such as a keyboard, a pointing device, and a display 1270), and may also communicate with one or a plurality of devices that enable a user to interact with the computing device 1200, and/or communicate with any device (such as a network card and a modem) that enables the computing device 1200 to communicate with one or a plurality of other computing devices. This communication may be performed through an input/output (I/O) interface 1230. Moreover, the computing device 1200 may also communicate with one or a plurality of networks (for example, a local area network (LAN), a wide area network (WAN) and/or a public network, for example, the Internet) through a network adapter 1240. As shown in FIG. 12, the network adapter 1240 communicates with other modules of the computing device 1200 through the bus 1250. It should be understood that although not shown in the figure, other hardware and/or software modules can be used in combination with the computing device 1200, including, but not limited to: microcode, device drivers, redundant processing units, external disk drive arrays, RAID systems, tape drives, data backup storage systems, and the like.

The processor 1220 executes various functional applications and data processing, such as implementing the procedures described in the present disclosure, by running programs stored in the storage apparatus 1210.

The technique described herein may be implemented with hardware, software, firmware, or any combination thereof, unless specifically described as being implemented in a specific manner. Any features described as modules or components may also be implemented together in an integrated logical apparatus, or separately implemented as discrete but interoperable logical apparatuses. If implemented with software, the technique may be implemented at least in part by a non-transitory processor-readable storage medium that includes instructions, where when executed, the instructions perform one or more of the aforementioned methods. The non-transitory processor-readable data storage medium may form part of a computer program product that may include an encapsulation material. Program code may be implemented in a high-level procedural programming language or an object-oriented programming language so as to communicate with a processing system. If desired, the program code may also be implemented in an assembly language or a machine language. In fact, the mechanisms described herein are not limited to the scope of any particular programming language. In any case, the language may be a compiled language or an interpreted language.

One or a plurality of aspects of at least some embodiments may be implemented by representative instructions that are stored in a machine-readable medium and represent various logic in a processor, where when read by a machine, the representative instructions cause the machine to manufacture the logic for executing the technique described herein.

Such machine-readable storage media may include, but are not limited to, a non-transitory tangible arrangement of an article manufactured or formed by a machine or device, including storage media, such as: a hard disk; any other types of disk, including a floppy disk, an optical disk, a compact disk read-only memory (CD-ROM), compact disk rewritable (CD-RW), and a magneto-optical disk; a semiconductor device such as a read-only memory (ROM), a random access memory (RAM) such as a dynamic random access memory (DRAM) and a static random access memory (SRAM), an erasable programmable read-only memory (EPROM), a flash memory, and an electrically erasable programmable read-only memory (EEPROM); a phase change memory (PCM); a magnetic or optical card; or any other type of medium suitable for storing electronic instructions.

Instructions may further be sent or received by means of a network interface device that uses any of a number of transport protocols (for example, Frame Relay, Internet Protocol (IP), Transfer Control Protocol (TCP), User Datagram Protocol (UDP), and Hypertext Transfer Protocol (HTTP)) and through a communication network using a transmission medium.

An exemplary communication network may include a local area network (LAN), a wide area network (WAN), a packet data network (for example, the Internet), a mobile phone network (for example, a cellular network), a plain old telephone service (POTS) network, and a wireless data network (for example, Institute of Electrical and Electronics Engineers (IEEE) 802.11 standards referred to as Wi-Fi®, and IEEE 802.19 standards referred to as WiMax®), IEEE 802.15.4 standards, a peer-to-peer (P2P) network, and the like. In an example, the network interface device may include one or a plurality of physical jacks (for example, Ethernet, coaxial, or phone jacks) or one or a plurality of antennas for connection to the communication network. In an example, the network interface device may include a plurality of antennas that wirelessly communicate using at least one technique of single-input multiple-output (SIMO), multiple-input multiple-output (MIMO), or multiple-input single-output (MISO) techniques.

The term “transmission medium” should be considered to include any intangible medium capable of storing, encoding, or carrying instructions for execution by a machine, and the “transmission medium” includes digital or analog communication signals or any other intangible medium for facilitating communication of such software.

So far, the CT image generating method and the image data reconstruction device according to the present invention have been described, and the computed tomography system and the computer-readable storage medium capable of implementing the method have also been described.

According to the techniques of the present disclosure, at the time of reconstructing projection measurement data of a diagnostic scan, a main region image within a scan field of view of the CT device and a truncated region image out of the scan field of view of the CT device are also reconstructed, and artifact removal reconstruction is enabled upon detecting that a substance that causes an artifact is present in a truncated region image. Compared with conventional reconstruction performed only for projection measurement data of a main region image, the techniques of the present disclosure can alleviate or eliminate the effect of an artifact caused by a substance in a truncated region. Artifact removal reconstruction can be correctly enabled when a substance that causes an artifact is present in a truncated region.

Some exemplary embodiments have been described above. However, it should be understood that various modifications can be made to the exemplary embodiments described above without departing from the spirit and scope of the present invention. For example, an appropriate result can be achieved if the described techniques are performed in a different order and/or if the components of the described system, architecture, apparatus, or circuit are combined in other manners and/or replaced or supplemented with additional components or equivalents thereof; accordingly, the modified other embodiments also fall within the protection scope of the claims.

1. A CT image generating method, comprising:
acquiring projection measurement data of an examination subject scanned by a CT device;
reconstructing an initial scan image on the basis of the projection measurement data, wherein the initial scan image comprises a plurality of slice images, and at least one of the plurality of slice images comprises a main region image within a scan field of view of the CT device and a truncated region image out of the scan field of view of the CT device;
determining whether a particular type of substance is present in the plurality of slice images; and
performing artifact removal reconstruction on at least one of the plurality of slice images in response to determining that the substance is present in a truncated region image of the plurality of slice images, the artifact removal reconstruction being used to remove, from the plurality of slice images, artifacts caused by the substance.

2. The method according to claim 1, wherein performing the artifact removal reconstruction on at least one of the plurality of slice images comprises:
determining artifact-affected sub-regions in the slice images, wherein each of the artifact-affected sub-regions indicates the presence of at least one of the substances;
performing the artifact removal on the artifact-affected sub-regions to acquire artifact-reduced sub-images; and
combining at least a portion of the at least one slice image with the artifact reduced sub-images.

3. The method according to claim 1, further comprising:
acquiring at least one scout image of the examination subject at at least one plain scan angle; and
determining an examination region of the examination subject on the basis of the at least one scout image.

4. The method according to claim 3, wherein the scout image is acquired by performing planar projection measurement on the subject at one of the at least one plain scan angle, and the projection measurement data is acquired by performing circumferential projection measurement on the examination region of the examination subject in an axial direction of a diagnostic scan.

5. The method according to claim 3, further comprising:
determining whether the substance is present in the at least one scout image and within the examination region or within a threshold range from the examination region; and
performing the artifact removal reconstruction on at least one of the plurality of slice images in response to determining that the substance is present in the at least one scout image and within the examination region or within the threshold range from the examination region.

6. The method according to claim 2, wherein combining at least a portion of the at least one slice image with the artifact-reduced sub-images comprises: combining at least one sub-image free of any artifact sub-regions in the at least one slice image with the artifact-reduced sub-images.

7. The method according to claim 2, wherein the artifact-affected sub-regions comprise a sub-region in which the substance is present and a sub-region in the vicinity of the substance.

8. The method according to claim 7, wherein the substance comprises a metallic substance.

9. The method according to claim 8, wherein the sub-region in the vicinity of the substance is further determined on the basis of one or more of the following:
the position of the substance;
the type of the substance;
the size of the substance; and
the shape of the substance.

10. The method according to claim 1, wherein whether the substance is present in each of the plurality of slice images is determined by means of deep learning.

11. An image data reconstruction device, comprising:
a data acquisition unit, configured to acquire projection measurement data of an examination subject scanned by a CT device;
a reconstruction unit, configured to reconstruct an original scan image on the basis of the projection measurement data, wherein the original scan image comprises a plurality of slice images, and at least one of the plurality of slice images comprises a main region image within a scan field of view of the CT device and a truncated region image out of the scan field of view of the CT device; and
a correction unit, configured to perform artifact removal reconstruction on the original scan image, the correction unit comprising:
a detection unit, configured to determine whether a particular type of substance is present in the plurality of slice images; and
an artifact removal reconstruction unit, configured to perform artifact removal reconstruction on at least one of the plurality of slice images in response to determining that the substance is present in a truncated region image of the plurality of slice images, the artifact removal reconstruction being used to remove, from the plurality of slice images, artifacts caused by the substance.

12. The image data reconstruction device according to claim 11, wherein the artifact removal reconstruction unit is configured to:
determine artifact-affected sub-regions in the slice images at least on the basis of the position of the substance, wherein each of the artifact-affected sub-regions indicates the presence of at least one of the substances;
perform the artifact removal reconstruction on the artifact-affected sub-regions at least on the basis of the position of the substance to acquire artifact-reduced sub-images; and
combine at least a portion of the at least one slice image with the artifact-reduced sub-images.

13. The image data reconstruction device according to claim 11, wherein the data acquisition unit is further configured to acquire at least one scout image of the examination subject at at least one plain scan angle.

14. The image data reconstruction device according to claim 13, wherein the scout image is acquired by performing planar projection measurement on the subject at one of the at least one plain scan angle, and the projection measurement data is acquired by performing circumferential projection measurement on the examination region of the examination subject in an axial direction of a diagnostic scan.

15. The image data reconstruction device according to claim 13, wherein the detection unit is further configured to: determine whether the substance is present in the at least one scout image and within the examination region or within a threshold range from the examination region, and the artifact removal reconstruction unit is further configured to: perform the artifact removal reconstruction on at least one of the plurality of slice images in response to determining that the substance is present in the at least one scout image and within the examination region or within the threshold range from the examination region.

16. The image data reconstruction device according to claim 12, wherein the artifact removal reconstruction unit is further configured to: combine at least one sub-image free of any artifact sub-regions in the at least one slice image with the artifact-reduced sub-images.

17. The image data reconstruction device according to claim 12, wherein the artifact-affected sub-regions comprise a sub-region in which the substance is present and a sub-region in the vicinity of the substance.

18. The image data reconstruction device according to claim 17, wherein the substance comprises a metallic substance.

19. The image data reconstruction device according to claim 18, wherein the sub-region in the vicinity of the substance is further determined on the basis of one or more of the following:
the position of the substance;
the type of the substance;
the size of the substance; and
the shape of the substance.

20. The image data reconstruction device according to claim 11, wherein the detection unit is configured to determine, by means of deep learning, whether the substance is present in each of the plurality of slice images.
